(19) United States
(12) Patent Application Publication
(10) Pub. No.: US 2010/0150813 A1
(43) Pub. Date: Jun. 17, 2010

(54) Method And Apparatus For Producing Carbon Monoxide By Cryogenic Distillation Using A Distillation Column System Supplied With A Mixture Of Which The Main Components Are At Least Hydrogen And Carbon Monoxide

(75) Inventors: Alain Briglia, Corze (FR); Arthur Darde, Paris (FR); Natacha Haik-Beraud, Champigny-Sur-Marne (FR); Marie-Khuny Khy, Shanghai (CN)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/525,330

(22) PCT Filed: Jan. 30, 2008
(86) PCT No.: PCT/FR2008/050148

§ 371 Date: Jan. 15, 2010

(30) Foreign Application Priority Data
Feb. 1, 2007 (FR) 0752999

(51) Int. Cl. C01B 31/18; F25J 3/00

(52) U.S. Cl. 423/418.2; 62/617

(57) ABSTRACT

A method and apparatus for producing carbon monoxide by cryogenic distillation is presented.

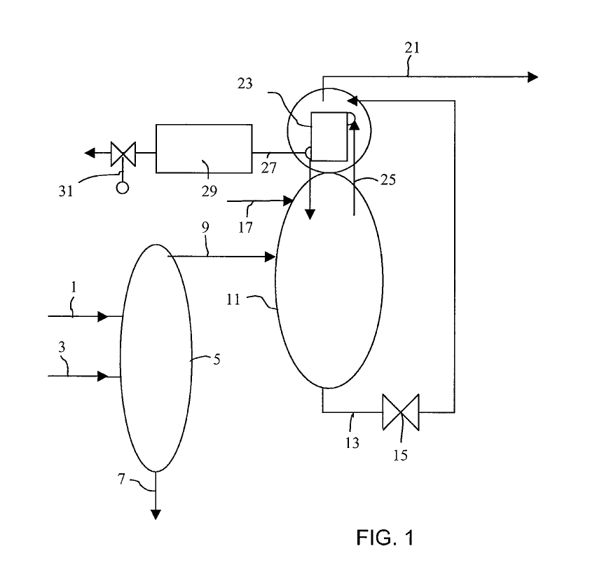

The present invention relates to a method and apparatus for producing carbon monoxide by cryogenic distillation. In known methods for producing hydrogen and/or carbon monoxide by cryogenic distillation, a denitrogenation column is frequently used in order to obtain products very low in nitrogen from a mixture to be separated that is contaminated with nitrogen.

It may however happen that the nitrogen content of the mixture to be separated is extremely small or even zero from time to time, while the unit has been designed with a denitrogenation column. This will thus be the case with a mixture to be separated produced by an SMR, fed temporarily with naphtha. Since regulation of the pressure of the denitrogenation column is made by controlling the nitrogen purge, it will no longer be possible to keep the pressure of this column constant. Since this pressure controls that of the CO/CH₄ column, generally upstream of the denitrogenation column, the operation of the unit will be caused to deteriorate considerably by probable fluctuations.

According to the invention, in order to solve the problem of lack of nitrogen in the feed gas, nitrogen is injected upstream of the denitrogenation column, preferably in the circuit followed by CO (from the synthesis gas or from the cycle), preferably at a low pressure, in this way enabling the denitrogenation column to operate.

According to one object of the invention, a method is provided for producing carbon monoxide by cryogenic distillation using a system of distillation columns fed with a mixture of at least hydrogen and carbon monoxide as the main components and at least part of the time nitrogen, wherein the mixture is separated in a system of columns comprising a denitrogenation column for producing a nitrogen-rich flow and a nitrogen-lean flow and a carbon monoxide-rich flow is withdrawn from the system of columns to serve as the product, characterized in that if the nitrogen content of the mixture falls below a given threshold, a nitrogen-rich fluid coming from an external source other than the source from which the mixture comes, is conveyed upstream of or into the denitrogenation column.

According to other optional objects:
the nitrogen-rich fluid is injected into a flow feeding the denitrogenation column or the nitrogen-rich fluid is injected directly into the denitrogenation column;
the nitrogen-rich fluid is injected at a temperature above −170° C., optionally above 0° C.;
the nitrogen-rich fluid is a liquid or gas;
if the nitrogen-rich flow is reduced below a given flow rate, the nitrogen-rich fluid coming from an external source other than the source from which the mixture comes, is conveyed upstream of the denitrogenation column;
the column system makes it possible to achieve partial condensation or methane washing upstream of the denitrogenation column.

According to another object of the invention, an installation for producing carbon monoxide by cryogenic distillation is provided, comprising a system of distillation columns, means for feeding the system of columns with a mixture comprising at least hydrogen and carbon monoxide as the main components and for at least part of the time nitrogen, the system of columns comprising a denitrogenation column for producing a nitrogen-rich flow and a nitrogen-lean flow and means for withdrawing a carbon monoxide-rich flow from the system of columns to serve as the product, and means for bringing a nitrogen-rich fluid coming from an external source other than the source from which the mixture comes, upstream of the denitrogenation column or as far as the denitrogenation column, characterized in that it comprises means for measuring:
i) the nitrogen content of the mixture, of a fluid from which the mixture is derived or of a fluid (9) feeding the denitrogenation column or
ii) the purge flow rate of a condenser (23) of the denitrogenation column or of the fluid feeding the denitrogenation column or
iii) the opening of an expansion valve (31) of the purge of a condenser of the denitrogenation column
and control means capable of conveying the nitrogen-rich fluid (17) coming from an external source other than the source from where the mixture comes, upstream of the denitrogenation column and/or to the denitrogenation column according to the measured content or the measured flow rate or the measured opening.

According to another object of the invention, in the installation:
the means for bringing a nitrogen-rich fluid coming from an external source are connected to an inlet of the denitrogenation column;
the installation includes means for measuring the nitrogen-rich flow rate and control means capable of conveying the nitrogen-rich fluid coming from an external source other than the source from where the mixture comes upstream of the denitrogenation column if the measured flow rate is less than a given threshold;
the column system includes means for carrying out partial condensation or methane washing upstream of the denitrogenation column.

The invention will be described in greater detail with reference to the FIGURE that illustrates an apparatus for producing carbon monoxide according to the invention.

The apparatus comprises at least two distillation columns, comprising a CO/CH₄ column 5 and a denitrogenation column 11.

The apparatus may form part of an installation with a methane washing step or a partial condensation step upstream of the CO/CH₄ column. The denitrogenation column may also be situated upstream of the CO/CH₄ column.

The CO/CH₄ column is fed by two flows 1, 3 at different levels and produces a liquid rich in methane 7 and a fluid 9 rich in carbon monoxide 9 but containing nitrogen at least part of the time. The fluid 9 is conveyed to the denitrogenation column 11 in the upper part of the column. The vessel liquid 13 is conveyed to a head condenser 23 of the denitrogenation column 11 in order to condense the nitrogen 25. A purge flow 27 is withdrawn from the condenser 23 and conveyed to a heat exchanger 29 where it evaporates and is expanded in a valve 31. The pressure of the denitrogenation column 11 is maintained by means of the purge flow 27.

If the nitrogen content of the flow 9 and/or the flow 9 itself and/or the purge flow 27 falls below a given threshold, a flow of liquid or gaseous nitrogen 17 is conveyed to the head of the denitrogenation column, until the nitrogen content of the flow 9 becomes acceptable.

Additionally or alternatively, it is possible to measure the nitrogen content of the mixture, or of a fluid from which the mixture is derived (for example natural gas) and to trigger the conveyance of nitrogen if this content is below a given threshold.

If not, it is possible to measure the flow rate of the fluid 9 feeding the denitrogenation column 11 and to trigger the conveyance of nitrogen if this content is below a given threshold.

Another alternative is to trigger the conveyance of nitrogen if the opening of the expansion valve 31 of the purge of a condenser of the denitrogenation column falls below a given threshold.

1-8. (canceled)

9. A method for producing carbon monoxide by cryogenic distillation using a system of distillation columns fed with a mixture of at least hydrogen and carbon monoxide as the main components and at least part of the time nitrogen, the method comprising;
separating the mixture in a system of columns comprising a denitrogenation column for producing a nitrogen-rich flow, a nitrogen-lean flow, and a carbon monoxide-rich flow is withdrawn from the system of columns to serve as the product, wherein if the nitrogen content of the mixture falls below a given threshold, a nitrogen-rich fluid coming from an external source other than the source from which the mixture comes, is conveyed upstream of and/or into the denitrogenation column.

10. The method of claim 9, wherein the nitrogen-rich fluid is injected into a flow feeding the denitrogenation column or the nitrogen-rich fluid is injected directly into the denitrogenation column.

11. The method of claim 9, wherein the nitrogen-rich fluid is injected at a temperature above −170° C.

12. The method of claim 11, wherein the nitrogen-rich fluid is injected at a temperature above 0° C.

13. The method of claim 9, wherein if the nitrogen-rich flow is reduced below a given flow rate, nitrogen coming from an external source other than the source from which the mixture comes, is conveyed upstream of the denitrogenation column.

14. The method of claim 9, wherein the system of columns makes it possible to achieve partial condensation or methane washing upstream of the denitrogenation column.

15. An installation for producing carbon monoxide by cryogenic distillation, comprising:
a system of distillation columns, means for feeding the system of columns with a mixture comprising at least hydrogen and carbon monoxide as the main components and for at least part of the time nitrogen, the system of columns comprising a denitrogenation column for producing a nitrogen-rich flow and a nitrogen-lean flow and means for withdrawing a carbon monoxide-rich flow from the system of columns to serve as the product, and means for bringing a nitrogen-rich fluid coming from an external source other than the source from which the mixture comes, upstream of the denitrogenation column or as far as the denitrogenation column, further comprising a means for measuring:
i) the nitrogen content of the mixture, of a fluid from which the mixture is derived or of a fluid (9) feeding the denitrogenation column or
ii) the purge flow rate of a condenser of the denitrogenation column or of the fluid feeding the denitrogenation column or
iii) the opening of an expansion valve of the purge of a condenser of the denitrogenation column
and control means capable of conveying the nitrogen-rich fluid coming from an external source other than the source from where the mixture comes, upstream of the denitrogenation column and/or to the denitrogenation column according to the measured content or the measured flow rate or the measured opening.

16. The installation of claim 15, wherein the means for bringing the nitrogen-rich fluid coming from an external source are connected to an inlet of the denitrogenation column.

17. The installation of claim 15, wherein the column system includes means for carrying out partial condensation or methane washing upstream of the denitrogenation column.
